(19) United States
(12) Patent Application Publication
(10) Pub. No.: US 2010/0117370 A1
(43) Pub. Date: May 13, 2010

(54) Power recycler using a stationary by-product wind source

(76) Inventor: Jo Anne Phelps, Chesapeake, VA (US)

Correspondence Address: BAMBI FAIVRE WALTERS, PC, PO BOX 5743, WILLIAMSBURG, VA, 23188, US

(21) Appl. No.: 12/590,751

(22) Filed: Nov. 13, 2009

Related U.S. Application Data
(60) Provisional application No. 61/114,298, filed on Nov. 13, 2008.

(51) Int. Cl. F03D 9/00

(52) U.S. Cl. 290/55

(57) ABSTRACT

According to exemplary embodiment, a power recycler device is provided for a stationary machine producing and expelling a byproduct wind source into an environment. The device includes a chassis configured to mount to or around the stationary machine. The device includes a turbine assembly supported by the chassis. The turbine assembly includes a plurality of turbine blades configured to be positioned perpendicular and adjacent to the expelled byproduct wind source. The turbine assembly is configured to harness the expelled byproduct wind source to create power.

### CROSS REFERENCE TO PROVISIONAL APPLICATION

This application claims priority benefit of Provisional Patent Application No. 61/114,298 filed Nov. 13, 2008, titled “PHELPS POWER RECYCLER”, and of which is incorporated herein by reference in its entirety.

### NOTICE OF COPYRIGHT PROTECTION

A portion of the disclosure of this patent document and its figures contain material subject to copyright protection. The copyright owner has no objection to the facsimile reproduction by anyone of the patent document or the patent disclosure, but otherwise reserves all copyrights whatsoever.

### BACKGROUND

I. Field

The invention relates to power recycling by capturing a stationary byproduct wind source.

II. Background

There are limited devices or machines capturing and storing a renewable energy source which are available to the general public and also cost effective. Solar technology is available but with significant drawbacks. Solar technology requires the home or office have access to direct sunlight for prolonged periods of time. However, trees or other obstructions (e.g., buildings and homes) in the environment can block the necessary sunlight source. Thus, solar technology is not practical in areas or environments that have trees and obstructions.

Another renewable energy source is wind. Windmill farms are being installed at selective locations to harness the natural wind source. However, the natural wind source is unpredictable and inconsistent in most cases. Current wind generators use unpredictable wind sources found in nature to spin a rotor to create power. There are various factors that reduce the power captured from natural wind, such as yaw control, a lack of a constant wind source, unpredictable wind directions, turbine placement restrictions, and cable distances from a turbine to a power utility or grid.

Some homeowner or business owners may install a windmill in their backyard or on their property which is very costly. The natural wind source in most areas is not available on a regular basis to harness the wind source required to create power. Thus, windmills are not generally practical or cost effective for the general consumer.

Thus, there is a continuing need for a system configured to harness wind from very predictable sources. The power recycler system of the present invention does not use wind found in nature to create power; instead, the power recycler system uses wind created as a byproduct of a stationary machine's fan, turbine, or exhaust.

### SUMMARY

The aforementioned problems, and other problems, are reduced, according to exemplary embodiments, by a power recycler device that captures or recycles from stationary machines a wind byproduct produced by the stationary machine to create power.

According to exemplary embodiment, a power recycler device is provided for a stationary machine producing and expelling a byproduct wind source into an environment. The device includes a chassis configured to mount to or around the stationary machine. The device includes a turbine assembly supported by the chassis. The turbine assembly includes a plurality of turbine blades configured to be positioned perpendicular and adjacent to the expelled byproduct wind source. The turbine assembly is configured to harness the expelled byproduct wind source to create power.

According to another exemplary embodiment, a power recycler system is provided. The power recycler system comprises a power recycler (PR) device for a stationary machine producing and expelling a byproduct wind source into an environment. The PR device comprises a chassis configured to mount to or around the stationary machine, and a turbine assembly supported by said chassis. The turbine assembly includes a plurality of turbine blades configured to be positioned perpendicular and adjacent to the expelled byproduct wind source, the turbine assembly being configured to harness the expelled byproduct wind source to create power. The system further includes a remote energy collector/storage assembly configured to store the power created remote from the PR device.

Other systems, methods, and/or products according to embodiments will be or become apparent to one with skill in the art upon review of the following drawings, and further description. It is intended that all such additional systems, methods, and/or products be included within this description, be within the scope of the present invention, and be protected by the accompanying claims.

### DESCRIPTION OF THE DRAWINGS

The above and other exemplary embodiments, objects, uses, advantages, and novel features are more clearly understood by reference to the following description taken in connection with the accompanying figures wherein:

FIG. 1 illustrates a perspective view of a power recycler device in accordance with some of the exemplary embodiments;

FIG. 2A illustrates a top view of the power recycler device straddling over a stationary machine in accordance with some of the exemplary embodiments;

FIG. 2B illustrates a side plan view of the power recycler device straddling over a stationary machine in accordance with some of the exemplary embodiments;

FIG. 3 illustrates a schematic view of the turbine assembly in accordance with some of the exemplary embodiments;

FIG. 4 illustrates a side view of yet another power recycler device in accordance with some of the exemplary embodiments;

FIG. 5 illustrates a perspective view of the power recycler device with a lid raised and mounted to a top of a stationary machine in accordance with some of the exemplary embodiments;

FIG. 6 illustrates a perspective view of the power recycler device mounted to a side of a stationary machine in accordance with some of the exemplary embodiments;

FIG. 7 illustrates a power recycler system in accordance with some of the exemplary embodiments;

FIG. 8 illustrates a top plan view of yet another power recycler device on a commercial size stationary machine in accordance with some of the exemplary embodiments; and

FIG. 9 illustrates a partial view of a support leg of a chassis of the power recycler device in accordance with some of the exemplary embodiments.

### DESCRIPTION

The word “exemplary” is used herein to mean “serving as an example, instance, or illustration.” Any configuration or design described herein as “exemplary” is not necessarily to be construed as preferred or advantageous over other configurations or designs. Furthermore, use of the words “present invention” is used herein to convey only some of the embodiments of the invention. For example, the word “present invention” would also include alternative embodiments and equivalent systems and components that one of ordinary skill in the art understands. An example is that the materials used for the exemplary embodiments may be made out of man-made materials, natural materials, and combinations thereof. A further example is that the apparatus or components of the apparatus may be manufactured by machine(s), human(s) and combinations thereof.

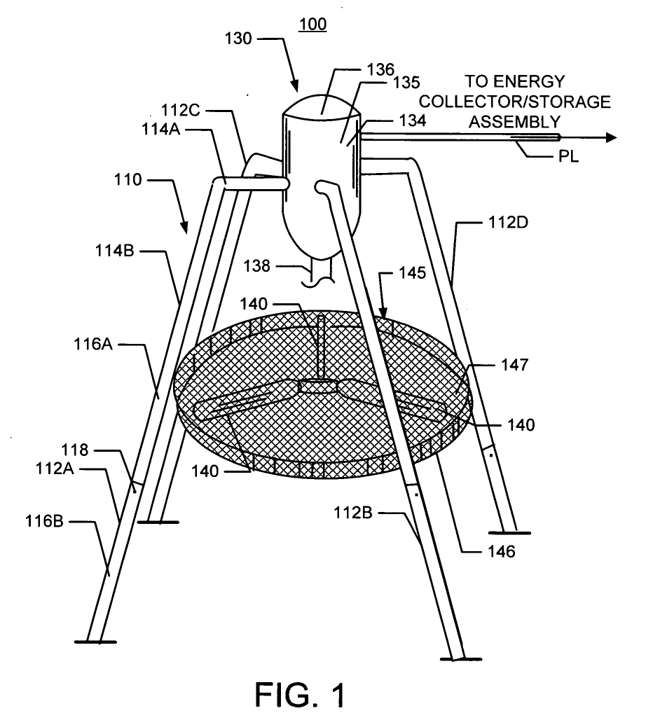

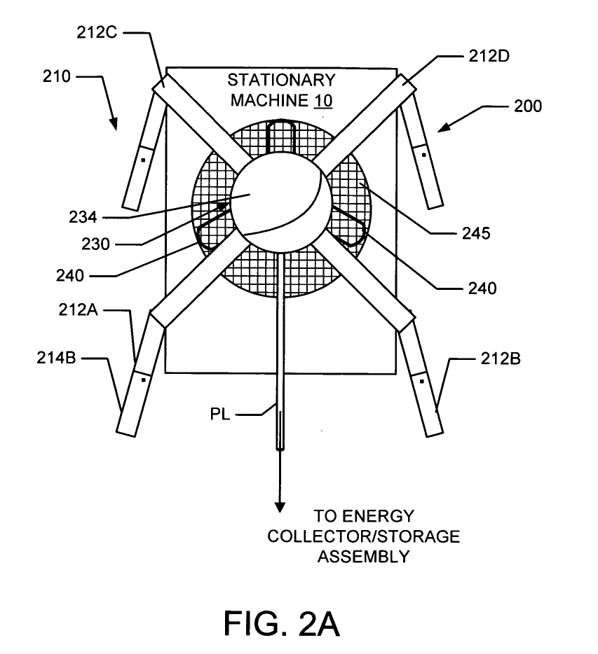

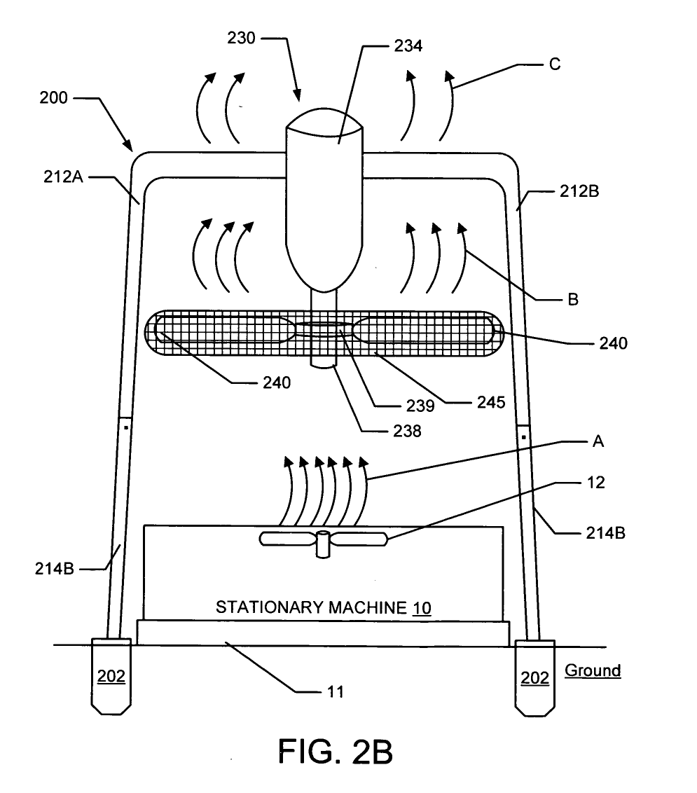

Within the descriptions of the figures, similar elements are provided similar names and reference numerals as those of the previous figure(s). Where a later figure utilizes the same element or a similar element in a different context or with different functionality, the element is provided a different leading numeral representative of the figure number (e.g., 1xx for FIGS. 1 and 2xx for FIG. 2). The specific numerals assigned to the elements are provided solely to aid in the description and not meant to imply any limitations (structural or functional) on the invention.

Some of the embodiments of the invention now will be described more fully hereinafter with reference to the accompanying drawings, in which exemplary embodiments are shown. This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Exemplary embodiments of the present invention relate to a power recycler (PR) device configured to create electrical power by harnessing expelled bi-product wind generated by stationary machines such as, without limitation, climate control units, air conditioning units, heat pumps, stationary machines with turbines, or any other stationary machines configured to produce and expel a predictable non-natural wind source.

The PR device includes a chassis that supports and suspends a turbine directly in the path of the expelled byproduct wind source such that the turbine blades rotate in a direction perpendicular to the flow of the expelled byproduct wind source. The turbine assembly, in one exemplary embodiment, is configured to be activated by the expelled byproduct wind source to turn the turbine blades of the rotor to create power.

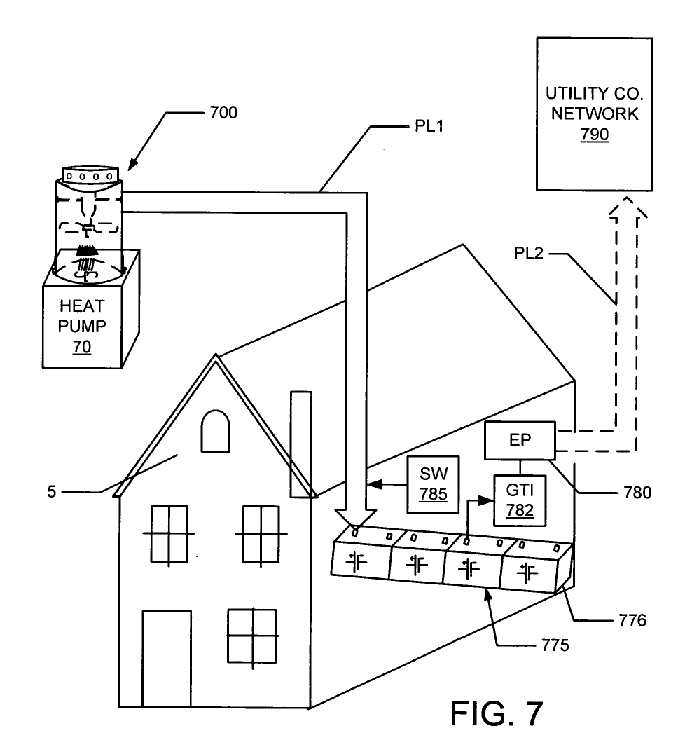

FIG. 1 illustrates a perspective view of a power recycler (PR) device 100 in accordance with some exemplary embodiments of the present invention. The PR device 100 includes, in general, a chassis 110 and turbine assembly 130 supported directly in the path of an expelled byproduct wind source of a stationary machine (FIG. 2A). The electric power created by the turbine assembly 130 is sent via power line PL to an energy collector/storage assembly 775 (FIG. 7).

The chassis 110 is a support structure, support assembly, mounting assembly or the like. In the exemplary embodiment, the chassis 110 includes a plurality of legs 112A, 112B, 112C and 112D. The plurality of legs 112A, 112B, 112C and 112D have a generally L-shape. However, the shape of the legs may vary. The plurality of legs 112A, 112B, 112C and 112D provide a support structure to stabilize, elevate and suspend the turbine assembly 130 adjacent to and in the direct path of the expelled byproduct wind source, as will be described in more detail later.

Since each of the plurality of legs 112A, 112B, 112C and 112D are essentially the same, only one leg will be described in more detail. The support leg 112A includes first and second leg sections 114A and 114B. The first leg section 114A has one end coupled to or integrated with a turbine control box housing 134. The first leg section 114A may be parallel to the horizon or ground. The other end of the first leg section is coupled at an angle with respect to the upper end of the second leg section 114B. In one exemplary embodiment, the first and second leg sections 114A and 114B may be coupled perpendicularly. However, in other exemplary embodiments, first and second leg sections 114A and 114B may be coupled at an obtuse angle.

A lower end of the second leg section 114B, in one exemplary embodiment, is configured to be mounted, affixed or stabilized to the ground so as to support and stabilize the turbine assembly 130, as will be discussed in more detail in relation to FIG. 2B. Alternately, the lower end of the second leg section 114B may be attached to a rooftop via base feet at the lower end.

The second leg section 114B has first and second section members 116A and 116B that are detachable and interconnectable. The lower end of the second section members 116B is configured to be mounted to the ground or alternately other surfaces. Thus, after the PR device 100 is installed, the turbine assembly 130 and a portion of the chassis 110 maybe lifted and removed without affecting the second section members 116B. The ability to remove the turbine assembly 130 allows easier removal of the PR device 100 for maintenance of the stationary machine or the device itself.

The first and second section members 116A and 116B are configured to be fastened together with a fastener 118, such as a set screw, a screw and bolt combination or the like. Other fasteners may be used such as a wing nut and screw, locking pins, etc.

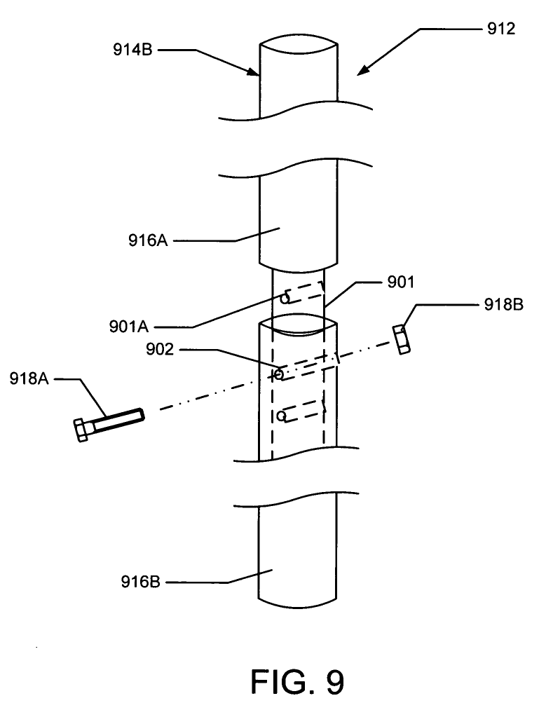

The length of the support leg 112A is adjustable, as will be discussed in more detail in relation to FIG. 9. The adjustable length allows the turbine assembly 130 to be lowered or elevated in relation to the stationary machine (FIG. 2B) so that the plurality of turbine blades 140 may be positioned inches from the vented output of the stationary machine. The adjustable length allows the turbine assembly 130 to be leveled, lowered, or elevated.

The legs may be made of metal. The gauge of the metal should support the weight and operation of the PR device 100 for the installation application. Nonetheless, the legs may be made of rigid plastic or other man-made materials, natural materials, combination of both man-made material and natural materials or the like.

The turbine assembly 130 includes a turbine control box (TCB) housing 134, a rotatable turbine drive shaft 138 (shown partially removed), and a plurality of turbine blades 140. The rotatable turbine drive shaft 138 is coupled to and within the TCB housing 134 and to the plurality of turbine blades 140. The plurality of turbine blades 140 have a length that fits within the area confined by the plurality of legs 112A, 112B, 112C and 112D. Furthermore, in one exemplary embodiment, the plurality of turbine blades 140 are housed within a blade cage housing 145. The blade cage housing 145 is dimensioned to fit within the area defined by the plurality of legs 112A, 112B, 112C and 112D. The blade cage housing 145 is configured to protect the plurality of blades, environment, surrounding plants, animals, etc.

The blade cage housing 145 encloses the plurality of blades 140 but still allows the wind source to enter and exit. The blade cage housing 145 is configured to prevent birds, animals and other species from engaging the plurality of blades 140 during operation and at other times. The blade cage housing 145 is configured to minimize or prevent nearby plants and foliage, if present, from growing on the plurality of blades 140 and interfering with the operation thereof. Nonetheless, the plants and foliage should be controlled in the area of the PR device 100.

The blade cage housing 145 is similar to a fan casing with surfaces that are apertured, mesh-like or grated to permit the expelled byproduct wind source to flow into a first side 146 of the blade cage housing 145 and engage the plurality of turbine blades 140. The blade cage housing 145 is also configured to pass, exit or flow out from a second side 147 the expelled byproduct wind source and any air flow generated by the rotation of the plurality of turbine blades 140. The wind source and any air flow exiting out of the blade cage housing 145 will hereinafter be referred to as the “turbine air flow.”

The TCB housing 134 of the turbine assembly 130 has a bullet shape, tear-drop shape, egg shape or other shapes that promote or does not impede the rapid flow of the turbine air flow around the TCB housing 134. Additionally, the TCB housing 134 includes a bottom housing section 135 and a lid 136.

In the exemplary embodiment, the top of the TCB housing 134 has the lid 136 to permit access to the interior of the TCB housing 134 or into the bottom housing section 135. The bottom end of the bottom housing section 135 has a more reduced and graduated diameter as compare to the top end (lid 136) of the TCB housing 134. The lid 136 may be locked or secured with fasteners (e.g., set screws) so that the TCB housing 134 is tamperproof. The lid 136 may also be hinged (not shown). The TCB housing 134 when closed may be waterproofed or weatherproofed via a rubber gasket between the lid 136 and the bottom housing section 135. Additionally, depending on the attachment of the plurality of legs 112A, 112B, 112C and 112D, waterproofing may be required between the legs and the TCB housing 134.

FIG. 2A illustrates a top view of the power recycler device 200 straddling over a stationary machine 10 in accordance with some exemplary embodiments of the present invention. FIG. 2B illustrates a side plan view of the power recycler device 200 straddling over a stationary machine 10 in accordance with some exemplary embodiments of the present invention. The PR device 200 includes, in general, a chassis 210 and turbine assembly 230 supported directly in the path of an expelled byproduct wind source of stationary machine 10. The electric power created by the turbine assembly 230 is sent via power line PL to an energy collector/storage assembly 775 (FIG. 7). The stationary machine 10 includes a fan or rotor 12. The rotor 12 produces a wind source as the result of its normal operation required for the stationary machine 10, such as used in an air conditioner, heat pump, etc. Thus, the wind source is a byproduct wind source and is man-made.

The stationary machine 10 includes a vent to allow such wind source to be expelled therefrom. Since the machine is stationary, the byproduct wind source is predictable, fixed and may be available on a more constant based as compared to a natural wind source. The vent is fixed in relation to the stationary device 10. Thereby, the PR device 200 can be configured or customized for the stationary machine 10 so as to maximize the ability of the PR device 200 to harness the byproduct wind source vented or expelled through the vent for the creation of the power. The PR device 200 is designed to not hamper, create drag, or interfere with the functionality of the stationary machine 10 creating the byproduct wind source.

The byproduct wind source is quantifiable. For example, based on a residentially-installed heat pump, the expelled byproduct wind source has been measured at a steady 22 mph wind output. The PR device 200 may be configured to this byproduct wind source.

The plurality of legs (only 212A and 212B shown) of chassis 210 have a generally L-shape and may be adjustable. The plurality of legs provide a support structure to stabilize, elevate and suspend the turbine assembly 230 adjacent to and in the direct path of the expelled byproduct wind source of the station machine 10. The turbine assembly 230 may be lowered inches (e.g., 5-10 inches) from the stationary machine 10. The closer the turbine assembly 230, less of the expelled byproduct wind source may escape into the surrounding environment before being harnessed by the plurality of turbine blades 240.

In the embodiments of FIGS. 2A and 2B, the chassis 210 straddles the stationary machine 10 such that the second leg section 214B of the plurality of legs (only 212A and 212B shown) are angled to wrap around the exterior of the stationary machine 10. The plurality of legs (only 212A and 212B) do not generally touch (but may be close to) the housing of the stationary machine 10.

In FIG. 2B, the bottom end of the second leg section 214B is shown mounted in the ground. For example, the second leg section 214B may be mounted with cement footing 202 within the ground. Alternately, other stabilizing systems, such as spikes, may be used or base feet mounted or attached via screws. The plurality of legs may include base feet for attachment to the stationary machine, the stationary machine's installation pad 11 (FIG. 2B) or other surfaces.

The turbine assembly 230 includes a turbine control box (TCB) housing 234, a rotatable turbine drive shaft 238 (FIG. 2B), and a plurality of turbine blades 240. As can be readily seen, the plurality of turbine blades 240 have a length that fits within the area confined by the plurality of legs. Additionally, the blade cage housing 245 is dimensioned to fit within the area defined by the plurality of legs (only 212A and 212B shown).

Below the TCB housing 234, the plurality of turbine blades 240 are attached to the drive shaft 238 via a turbine blade retention bracket 239 in the blade cage housing 245. The plurality of turbine blades 240 are oriented to be perpendicular to the flow direction of the expelled byproduct wind source, denoted by Arrows A, from the stationary machine 10. In some exemplary embodiment, installation of the PR device 200 places the turbine assembly 230 directly above or adjacent to the exhaust/cooling fan output of a heat pump or compressor of an air conditioning unit.

The expelled byproduct wind source, denoted by Arrows A, flow and enter the blade cage housing 245 to engage the plurality of blades 240. The turbine air flow, denoted by the Arrows B, exits the blade cage housing 245. The turbine air flow, denoted by the Arrows B, moves around and up along the TCB housing 234 as the turbine air flow, denoted by Arrows C, merges with the ambient air.

The blade shape, the number of blades and blade size may determined by an anemometer reading associated with the stationary machine 10. In the exemplary embodiment, there are three (3) turbine blades.

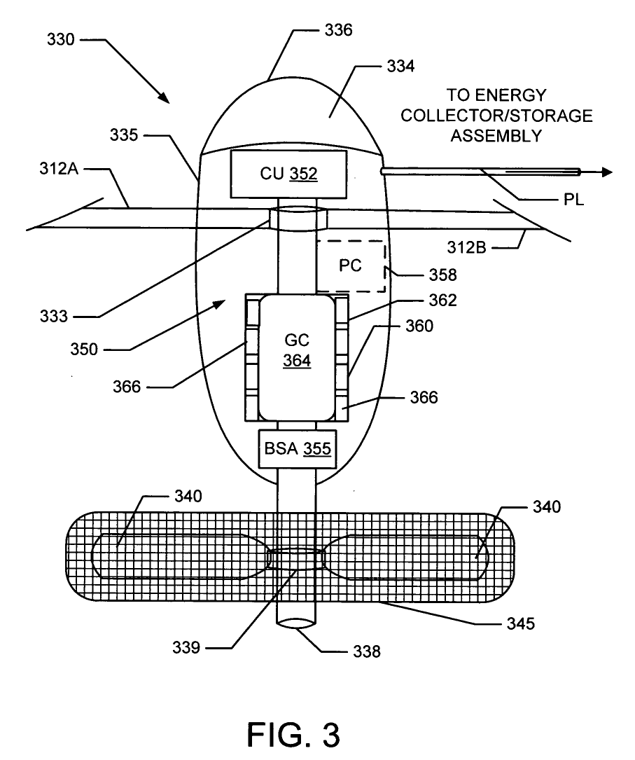

FIG. 3 illustrates a schematic view of the turbine assembly 330 in accordance with some exemplary embodiments of the present invention. In FIG. 3, the interior of the turbine assembly 330 is shown. The plurality of legs (only portions 312A and 312B shown) are coupled together at a center bracket or hub 333. Each leg radiates from bracket or hub 333 and extends out through the bottom housing section 335.

In the exemplary embodiment, the top of the TCB housing 334 has a lid 336 to permit access to the interior of the TCB housing 334 or into the bottom housing section 335. In the exemplary embodiment, the TCB housing 334 may be waterproofed or weatherproofed such as by gaskets, rubber gaskets, etc.

The turbine assembly 330 includes a plurality of turbine blades 340 attached to the drive shaft 338 via a turbine blade retention bracket 339 in a blade cage housing 345. The plurality of turbine blades 340 are oriented to be perpendicular to the flow direction of the expelled byproduct wind source.

The TCB housing 334 houses the power generating assembly 350 therein. The power generating assembly 350 includes a control unit 352, a portion of the drive shaft 338, brake safety assembly 355, power convertor 358 (optional), and generator 360.

The CU 352 is configured to control the plurality of blades 340, and power distribution (customized to each installation) out of the TCB housing 334 on power line PL. Depending on the site regulations, a power convertor 358 may be included. The power convertor 358 converts DC to AC or may convert AC to DC. Nonetheless, the power convertor 358 may be located in the dwelling or building. The generator 360 has a generator housing 362 mounted to and surrounding the drive shaft 338. The generator 360 includes a generator core (GC) 364 and one or more magnets 366.

When the exhaust/cooling fan or rotor begins to create the byproduct wind source, denoted by Arrows A of FIG. 2B, the plurality of turbine blades 340 spin the drive shaft 338 which in turn rotates the generator 360 in a conventional manner to create electricity. This electricity is then sent by the CU 352 or may be sent directly or indirectly to power line PL so that the electricity is collected and saved via battery storage, reused by the installation site, or returned to a power grid. All electricity use options must be inline with local regulations covering the installation site.

The generator 360 may be varied for various mounts such as a vertical or horizontal axis in design. The generator core 364 encircles the drive shaft 338 of the same orientation. Thus, the generator may be selected based on the driver shaft 338 orientation.

The PR device may be installed such that the plurality of blades 340 of turbine assembly 330 are suspended inches above, below or adjacent to and perpendicular to the vent or byproduct wind source outlet. Such an arrangement differs from natural wind turbine installations averting many aesthetic and wind accessibility concerns for residential and commercial wind turbine regulations.

The CU 352 includes an onboard computer or processor to control the power generated and provides shut down of production of power in certain safety scenarios. The onboard computer or processor also regulates power produced. The CU 253 includes a solid state control box to control the wind turbine assembly's operation providing start up, on/off control, and/or safety protocols. A safety (kill) switch 785 (FIG. 7) may be located at the dwelling or building for emergency stops. Each installation will need customization to the site. Thus, the CU 352 would be in communication with the system in the dwelling or building to receive the emergency stop signal or other control signals.

The turbine assembly 330 can have either an alternator (A/C) or a generator (DC) or both. The alternator/generator is customized to the site of the stationary machine creating the wind in line with the needs of the site and the local electrical regulations (grid tie or off grid use).

The brake safety assembly 355 includes a brake, disc or drum, which can be applied mechanically, electrically, or hydraulically to stop the drive shaft 338 when needed. The safety (kill) switch 785 (FIG. 7) in the dwelling or building may activate the brake safety assembly 355 directly or indirectly.

The PR devices described herein differs from natural wind turbines in that the PR devices will not need a yaw or furrowing control in the more efficient horizontal axis design. Since the stationary machine's byproduct wind source is generally uniform, the turbine assembly 330 and/or PR device will not suffer from cyclic stress fatigue on the axel and bearing features. Installation will also differ in that the PR device and/or turbine assembly 330 is positioned generally low to the ground or surface (rooftop) and does not require a tower to elevate the plurality of turbine blades 340 high up in the sky. The PR device may be mounted to a stationary machine that is on a rooftop. In such an instance, the plurality of legs would be mounted directly or indirectly to the roof top or to the stationary machine.

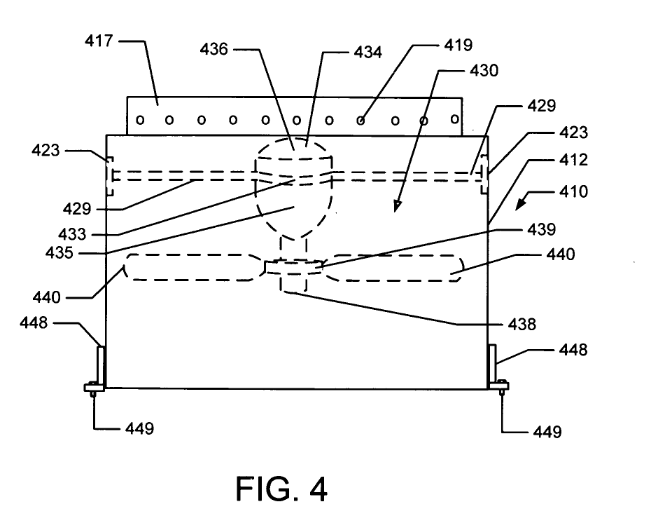

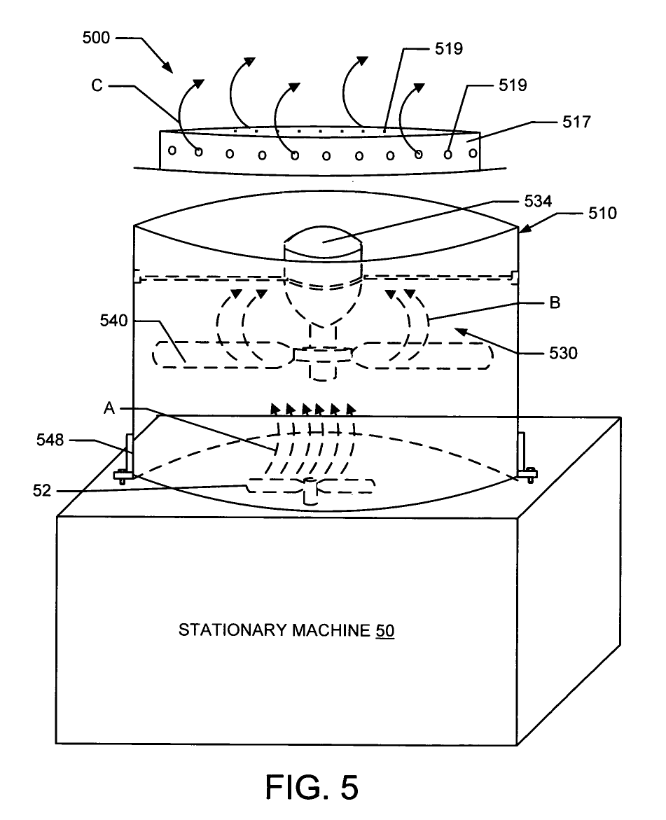

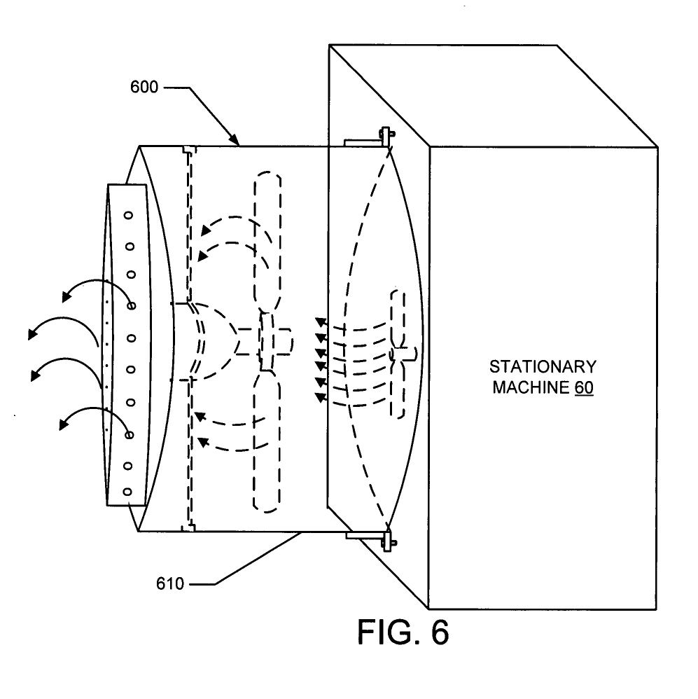

FIG. 4 illustrates a side view of yet another power recycler device 400 in accordance with some exemplary embodiments of the present invention. In the embodiment of FIG. 4, in lieu of the blade cage housing, a vented tube axial mount chassis 410 is provided. The PR device 400 includes, in general, chassis 410 and turbine assembly 430 supported directly in the path of an expelled byproduct wind source of a stationary machine 50 (FIG. 5) or 60 (FIG. 6). The electric power created by the turbine assembly 430 is sent via power line (e.g., PL of FIG. 1) to an energy collector/storage assembly 775 (FIG. 7).

The turbine assembly 430 includes a turbine control box (TCB) housing 334, a rotatable turbine drive shaft 438, and a plurality of turbine blades 440. The rotatable turbine drive shaft 438 is coupled to and within the TCB housing 434 and to the plurality of turbine blades 440. The plurality of turbine blades 440 have a length that fits within the area confined by the chassis 410. The plurality of turbine blades 440 are connected to a turbine blade retention bracket 439. Furthermore, in the exemplary embodiment, the plurality of turbine blades 440 do not require a blade cage housing. Instead, the chassis 410 is configured to protect the plurality of blades 440, the environment, surrounding plants, animals, etc. The operation of the turbine assembly 430 is essentially the same as turbine assembly 330.

The chassis 410 encloses the plurality of blades 440 but still allows the wind source to enter and exit. The chassis 410 is configured to prevent birds, animals and other species from engaging the plurality of blades 440 during operation and at other times. The chassis 410 is configured to minimize or prevent nearby plants and foliage, if present, from growing on the plurality of blades 440 and interfering with the operation thereof. Nonetheless, the plants and foliage should be controlled in the area of the PR device 400.

The vented tube axial mount chassis 410 includes an upright perimeter wall structure 412. In one exemplary embodiment, the upright perimeter wall structure 412 has a cylindrical shape and is hollow within. The wall structure 412 is configured to be mounted to the stationary machine 50 (FIG. 5) or 60 (FIG. 6) via a plurality of brackets 448. In an exemplary embodiment, the plurality of brackets 448 are L-shaped brackets configured to be welded or otherwise fastened to a bottom end of the upright perimeter wall structure 412. The plurality of L-shaped brackets serve as base feet for coupling, mounting or affixing the PR device 400 to the stationary machine, as be seen in FIG. 5 or 6. The brackets 448 may also be mounted on the interior of the upright perimeter wall structure 412. The brackets 448 are fastened via fasteners 449. The fasteners 449 are bolts, screws and/or nuts and allows the PR device 400 to be removed for maintenance. Other fastening systems such as clamps, adhesives, bonding materials, etc. may be used.

The upright perimeter wall structure 412 forms an enclosure with a hollow interior with an open bottom and open top. The upright perimeter wall structure 412 may require leveling so that the plurality of turbine blades 440 are level. The installer may use shims or washers as appropriate.

The vented tube axial mount chassis 410 further includes a lid 417. The lid 417 is configured to be vented and includes a plurality of vent holes 419 to permit the turbine air flow to exit. The vent holes 419 are located in a plurality of surfaces of the lid 417.

In the exemplary embodiment, the lid 417 is shown with a raised vented portion. The raised vented portion is above a top edge of the upright perimeter wall structure 412. Nonetheless, the lid 417 may be a recessed below the top edge of the upright perimeter wall structure 412. In a still further alternate embodiment, the lid 417 may be flush with the top edge of the upright perimeter wall structure 412. The top surface of the lid 417 also include vent holes, as best seen in FIG. 5.

The TCB housing 434 of the turbine assembly 430 has a bullet shape, tear-drop shape, egg shape or other shapes that promote or does not impede the rapid flow of the turbine air flow around the TCB housing 434. Additionally, the TCB housing 434 includes a bottom housing section 435 and a lid 436.

In the exemplary embodiment, the top of the TCB housing 434 has the lid 436 to permit access to the interior of the TCB housing 434 or into the bottom housing section 435. The bottom end of the bottom housing section 435 has a more reduced and graduated diameter as compare to the top end (lid 136) of the TCB housing 434. The lid 436 may also be hinged (not shown). The TCB housing 434 is attached, mounted or affixed to sides of the upright perimeter wall structure 412 via a plurality of support arms 429. One end of the support arms 429 are affixed, attached, mounted or welded to the upright perimeter wall structure 412 via coupling pads 423. The coupling pads 423 may be attached via welding or fasteners. The support arms 429 are attached to the TCB housing 434 via a band 433 affixed to the outer perimeter of the TCB housing 434.

In the exemplary embodiment, the coupling pads 423 are coupled to the TCB housing 434. The support arms 417 are coupled to a band 433 surrounding or integrated with the bottom housing section 435.

FIG. 5 illustrates a perspective view of the power recycler device 500 with a lid 517 raised and mounted to a top of a stationary machine 50 in accordance with some exemplary embodiments of the present invention. The PR device 500 operates in the same manner as the PR device 400 previously described. The PR device 500 includes, in general, a vented tube axial mount chassis 510 and turbine assembly 530 supported directly in the path of an expelled byproduct wind source of stationary machine 50. The electric power created by the turbine assembly 530 is sent via power line to an energy collector/storage assembly 775 (FIG. 7). The stationary machine 50 includes a fan or rotor 52. The rotor 52 produces a wind source as the result of its normal operation required for the stationary machine 50, such as used in an air conditioner, heat pump, etc. Thus, the wind source is a byproduct wind source and is man-made. The stationary machine 50 includes a vent to allow such wind source to be expelled therefrom. Since the machine is stationary, the byproduct wind source is predictable and may be available on a more constant basis. The vent is fixed in relation to the stationary device 50. Thereby, the PR device 500 can be configured or customized for the stationary machine 50 so as to maximize the ability of the PR device 500 to harness the byproduct wind source vented or expelled through the vent for the creation of the power.

The turbine assembly 530 may be lowered inches (e.g., 5-10 inches) from the stationary machine 50.

The plurality of turbine blades 540 are oriented to be perpendicular to the flow direction of the expelled byproduct wind source, denoted by Arrows A, from the stationary machine 50. In some exemplary embodiments, installation of the PR device 500 places the turbine assembly 530 directly above or adjacent to the exhaust/cooling fan output of a heat pump or compressor of an air conditioning unit. The chassis 510 is configured to be mounted to the stationary device 50 via brackets 548 and fasteners. The chassis 510 has a diameter that should surround the vent of the stationary machine 50 to maximize the amount of the expelled byproduct wind source collected.

The expelled byproduct wind source, denoted by Arrows A, flow and enter the chassis 510 to engage the plurality of blades 540. The turbine air flow, denoted by the Arrows B, exits the chassis 510 via lid 517 at vent holes 519. The turbine air flow, denoted by the Arrows B, moves around and up along the TCB housing 534 as the turbine air flow merges with the ambient air.

The blade shape, the number of blades and blade size may determined by an anemometer reading associated with the stationary machine 50.

FIG. 6 illustrates a perspective view of the power recycler device 600 mounted to a side of a stationary machine 60 in accordance with some exemplary embodiments of the present invention. The device 600 is essentially the same as a device 500 except that the chassis 610 of the PR device 600 is mounted along a plane which is essentially 90 degrees offset form the orientation of FIG. 5.

The chassis 610 of PR device 600 may be mounted in a plurality of directions. For example, if the vent was formed in an underside of a stationary machine, the chassis may be mounted around the vent to the underside of the stationary machine.

FIG. 7 illustrates a power recycler (PR) system in accordance with some exemplary embodiments of the present invention. The PR system includes a stationary machine (heat pump 70) at a dwelling or building 5. The PR system includes a PR device 700 configured to create electricity from the expelled byproduct wind source of the stationary machine (heat pump 70). The PR device 700 sends the generated electricity or power on power line PL1 to the dwelling or building 5 so that it is stored in an energy collector/storage assembly 775.

The energy collector/storage assembly 775 includes one or more batteries 776 configured to store and collect energy. The energy collector/storage assembly 775 is connected to a grid tie inverter (GTI) 782 (optional). The GTI 782 is coupled to an electrical panel (EP) 780 of the dwelling or building 5 to distribute electricity to the appliances, lights, etc. of the dwelling or building. Depending on local regulations, the electrical panel (EP) 780 may also send power back to the utility company network 790 on power line PL2. Power line PL2 is shown dashed to denote an optional feature. The illustrations of FIG. 7 and connections may vary based on local regulations.

In operation, power can be stored in batteries 776 or preferably put back into the power grid. Use of the PR device 700 in an off grid, grid tied or hybrid power configurations will positively affect a site's carbon neutral rating. Location, unpredictability, grid outage, and aesthetic concerns of wind generators are nullified by the design of the PR device 700.

The PR device 700 captures the power of the bi-product wind source from the heat pump 70 or other stationary machine with its turbine blades. The PR device 700 is mounted low to or immediately adjacent to the byproduct wind source of heat pump 70 or other stationary machine. The wind source causes the blade to turn the drive shaft to generate and create power from the wind source. The power generated is utilized in a customized fashion such as to power batteries 776, on site systems, or return it to the local power grid in line with local state and utility regulations which vary by region.

A PR system also includes a safety (kill) switch 785 located at/in the dwelling or building 5 where power is switched to the grid or stored. The switch 785 may be used in power outages, windstorms or other times to prevent damage to the PR device 700 or dwelling/building.

The GTI 782 controls the kind of the electricity created from DC to AC and facilitates returning power to the power grid when not storing power in batteries 776. The power created by the wind turbine is either directly stored in batteries 776 or returned to a power grid. The specific dimensions and design of the PR device 700 may vary with the geographical location, local regulations, and wind source type and direction.

The PR system shown in FIG. 7 illustrates only one heat pump 70 or stationary machine. Depending on the size of the dwelling such as a residence, or office building one or more stationary machines may be available. Thus, PR system may have multiple stationary machines and multiple PR devices 700 all communicating the created electricity back to the dwelling or building 5.

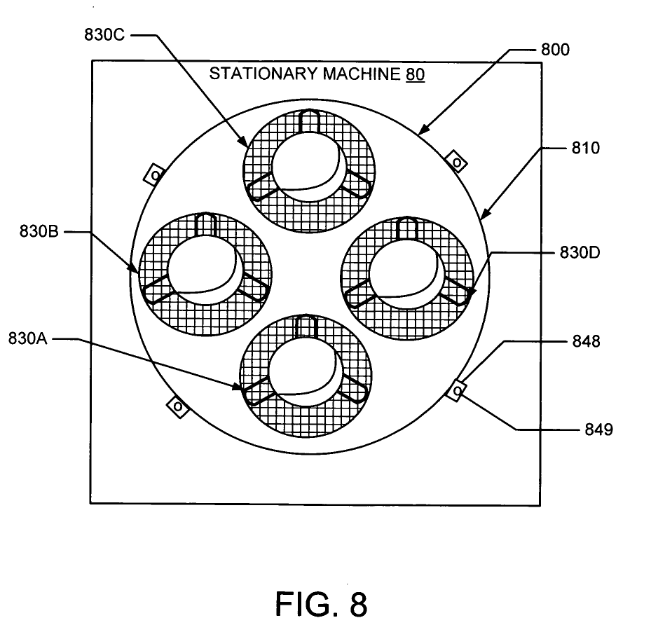

FIG. 8 illustrates a top plan view of yet another power recycler (PR) device 800 on a commercial size stationary machine 80 in accordance with some exemplary embodiments of the present invention. The PR device 800 includes, in general, a vented tube axial mount chassis 810 and a plurality of turbine assemblies 830A, 830B, 830C and 830D supported directly in the path of an expelled byproduct wind source(s) of stationary machine 80. The electric power created by the plurality of turbine assemblies 830A, 830B, 830C and 830D is sent via a power line to an energy collector/storage assembly 775 (FIG. 7).

The chassis 810 is configured to be mounted to the stationary machine 80 via brackets 848 and fasteners 849.

The stationary machine 80 includes one or more fans or rotors. The fans or rotors produce a wind source as the result of its normal operation required for the stationary machine 80. Depending on the number of vents and/or size of the vents, one PR device 800 may be used or a plurality of PR devices 400 may be used. In some circumstances the stationary machine may be so large that more than one PR device 800 would be required to fully utilize the byproduct wind source of a single or group of stationary machines.

As can be appreciated, one or more combination of PR devices 400 and 800 may be used.

With specific reference also to FIG. 9, a partial view is shown of a support leg 912 of the chassis of the PR device 100 in accordance with some exemplary embodiments of the present invention. More specifically, the second leg section 914B has first and second section members 916A and 916B that are detachable and interconnectable. The lower end of the second section members 916B is configured to be mounted to the ground or alternately other surfaces.

The first second member 916A includes a bottom connector end 901 configured to be received into a top opening of the second section member 916B. The bottom connector end 901 includes a plurality of channels 901A. The second section member 916B includes a through hole 902 configured to align with one of the plurality of channels 901A. The channels 901A are formed in series along a length of the bottom connector end 901. The channel 901A when aligned with through hole 902 may be fastened together via fasteners 918A and 918B (screw and nut). The fasteners 918A may be a hex screw or other screws. Other fastener systems such as a locking pin, or set screw may be used. Based on the channel 901A selected, the length of the support leg 912 may be varied.

The PR devices described above are configured to recycle power already generated by stationary machines. Thus, the PR devices create more power from the use of the stationary machine by harnessing the expelled byproduct wind or exhaust flowing at a sufficient rate at the discharge point or cooling fan of the stationary machine. Thus, power is created and/or recycled from expended power of the stationary machine.

The PR devices do not have to be connected to the stationary machine creating the wind source and do not hamper, creates drag, or interfere with the functionality of the stationary machine creating the byproduct wind source.

The PR device is unique by virtue of the use of non-natural and stationary wind sources in the creation of power. Current wind generators use the unpredictable wind found in nature to spin the rotor to create power. By contrast, the PR devices uses predictable, stable machine byproduct wind to create power. Non-natural wind sources include but are not limited to climate control units, turbines, or any other non-natural wind sources generated by stationary machines.

In view of the foregoing, the PR device captures the byproduct wind source of a stationary machine with a plurality of turbine blades which turn the shaft to generate and create power. Thus, the byproduct wind source is recycled machine made byproduct wind. Any wind generated by a standing or stationary machine can be harnessed by the PR device to create electricity therefrom. The power generated may be utilized in a customized fashion such as to power batteries, on site systems, or return it to the local power grid in line with local state and utility regulations which vary by region.

Due to the vast numbers of models, sizes, and byproduct wind source outputs of stationary machines creating a wind source, the PR devices may be configured to vary the generator, turbine assembly, chassis, blade size, blade length, blade pitch and/or shape. The PR device is configured to be varied for byproduct wind source output placement and mounting to gain the maximum power output by the PR device.

In view of the foregoing, the present invention contemplates a combination stationary machine with an onboard PR device. Thus, according to alternate exemplary embodiments, the turbine assembly and/or chassis may be integrated into the housing of the stationary machine (not shown) so that the vented or expelled byproduct wind source can be recycled into power and energy.

While the present invention has been described with respect to various features, aspects, and embodiments, those skilled and unskilled in the art will recognize the invention is not so limited. Other variations, modifications, and alternative embodiments may be made without departing from the spirit and scope of the present invention.

What is claimed is:

1. A power recycler device for a stationary machine producing and expelling a byproduct wind source into an environment, the device comprising:
a chassis configured to mount to or around the stationary machine; and
a turbine assembly supported by said chassis and having a plurality of turbine blades configured to be positioned perpendicular and adjacent to the expelled byproduct wind source, the turbine assembly being configured to harness the expelled byproduct wind source to create power.

2. The device according to claim 1, wherein the chassis supports and suspends the turbine assembly directly in a path of the expelled byproduct wind source.

3. The device according to claim 1, wherein the turbine assembly includes a generator activated by the expelled byproduct wind source to turn the plurality of turbine blades to create power.

4. The device according to claim 1, wherein the turbine assembly further comprises:
a turbine housing;
a drive shaft coupled to and within the turbine housing wherein the plurality of turbine blades are coupled to one end of the drive shaft;
a power generating assembly housed in the turbine housing; and
a blade cage housing enclosing the plurality of turbine blades below the turbine housing.

5. The device according to claim 4, wherein the chassis is vented and includes:
an upright perimeter wall structure forming an enclosure with a hollow interior with an open bottom and open top;
a lid coupled to a top edge of the upright perimeter wall structure to close the open top;
a plurality of brackets coupled to a bottom of the upright perimeter wall structure, the plurality of brackets configured to mount the upright perimeter wall structure to the stationary machine; and
a plurality of support arms coupled to the turbine housing of the turbine assembly, the plurality of support arms support and suspend the turbine assembly directly in the path of the expelled byproduct wind source within the upright perimeter wall structure.

6. The device according to claim 4, wherein the chassis includes:
a plurality of legs configured to straddle the stationary machine and support and suspend the turbine housing of the turbine assembly directly in the path of the expelled byproduct wind source.

7. The device according to claim 6, wherein the plurality of legs are adjustable in length.

8. The device according to claim 1, further comprising a plurality of turbine assemblies, wherein each turbine assembly is supported by said chassis and has a different plurality of turbine blades configured to be positioned perpendicular and adjacent to the expelled byproduct wind source, said each turbine assembly being configured to harness the expelled byproduct wind source to create the power.

9. The device according to claim 1, further comprising means for delivering the power created to a dwelling or building.

10. A power recycler system comprising:
a power recycler (PR) device for a stationary machine producing and expelling a byproduct wind source into an environment, the PR device comprising:
a chassis configured to mount to or around the stationary machine, and
a turbine assembly supported by said chassis and having a plurality of turbine blades configured to be positioned perpendicular and adjacent to the expelled byproduct wind source, the turbine assembly being configured to harness the expelled byproduct wind source to create power; and
a remote energy collector/storage assembly configured to store the power created remote from the PR device.

11. The system according to claim 10, wherein the chassis supports and suspends the turbine assembly directly in a path of the expelled byproduct wind source.

12. The system according to claim 10, wherein the turbine assembly includes a generator activated by the expelled byproduct wind source to turn the plurality of turbine blades to create power.

13. The system according to claim 10, wherein the turbine assembly further comprises:
a turbine housing;
a drive shaft coupled to and within the turbine housing wherein the plurality of turbine blades are coupled to one end of the drive shaft;
a power generating assembly housed in the turbine housing; and
a blade cage housing enclosing the plurality of turbine blades below the turbine housing.

14. The system according to claim 13, wherein the chassis is vented and includes:
an upright perimeter wall structure forming an enclosure with a hollow interior with an open bottom and open top;
a lid coupled to a top edge of the upright perimeter wall structure to close the open top;
a plurality of brackets coupled to a bottom of the upright perimeter wall structure, the plurality of brackets configured to mount the upright perimeter wall structure to the stationary machine; and
a plurality of support arms coupled to the turbine housing of the turbine assembly, the plurality of support arms support and suspend the turbine assembly directly in the path of the expelled byproduct wind source within the upright perimeter wall structure.

15. The system according to claim 13, wherein the chassis includes:
a plurality of legs configured to straddle the stationary machine and support and suspend the turbine housing of the turbine assembly directly in the path of the expelled byproduct wind source.

16. The system according to claim 15, wherein the plurality of legs are adjustable in length.

17. The system according to claim 10, wherein the PR device further comprises a plurality of turbine assemblies, wherein each turbine assembly is supported by said chassis of said PR device and has a different plurality of turbine blades configured to be positioned perpendicular and adjacent to the expelled byproduct wind source, said each turbine assembly being configured to harness the expelled byproduct wind source to create the power.

18. The system according to claim 10, further comprising means for delivering the power created to a dwelling or building.

19. The system according to claim 18, further comprising:
an electrical panel coupled to a dwelling; and
a grid tie inverter coupled to the remote energy collector/storage assembly and electrical panel wherein the electrical panel delivers the power to appliances and lighting in the dwelling or building from the remote energy collector/storage assembly.

20. A power recycler comprising:
a power recycler (PR) device for a stationary machine producing and expelling a byproduct wind source into an environment, the PR device comprising:
a chassis configured to mount within a housing of a stationary machine, and
a turbine assembly supported by said chassis and having a plurality of turbine blades configured to be positioned substantially perpendicular and adjacent to the expelled byproduct wind source, the turbine assembly being configured to harness the expelled byproduct wind source to create power; and
a remote energy collector/storage assembly configured to store the power created remote from the PR device.
